(19) United States
(12) Patent Application Publication
(10) Pub. No.: US 2026/0236228 A1
(43) Pub. Date: Aug. 13, 2026

(54) PRE-QUANTIZATION CIRCUITRY AND PRE-QUANTIZATION METHOD FOR COMPUTING-IN-MEMORY

(71) Applicant: NATIONAL CHENG KUNG UNIVERSITY, Tainan City (TW)

(72) Inventors: Soon-Jyh CHANG, Tainan City (TW); Zu-Cheng SHENG, Tainan City (TW); Chun-Wei CHEN, Tainan City (TW)

(21) Appl. No.: 19/530,322

(22) Filed: Feb. 4, 2026

(30) Foreign Application Priority Data
Feb. 8, 2025 (TW) 114104759

(51) Int. Cl. G06F 7/52; G06F 7/48

(52) U.S. Cl. CPC G06F 7/52; G06F 7/48

(57) ABSTRACT

A pre-quantization circuitry for computing-in-memory, including an analog multiply-accumulate circuitry and an analog-to-digital converter (ADC). The analog multiply-accumulate circuitry is configured to receive a set of weights from a data memory and allocate them on a computing memory, and receive an input feature from a register, and then perform a multiply-accumulation (MAC) operation utilizing the set of weights and the input feature to generate an operation result in a form of an analog voltage/current. The ADC is configured to convert the analog voltage/current into a corresponding digital code. The analog multiply-accumulate circuitry is further configured to determine the pre-quantization information of the ADC before performing the MAC operation. The ADC is further configured to adjust the conversion bit number of the ADC based on the pre-quantization information.

### RELATED APPLICATIONS

This application claims priority to Taiwan Application Serial Number 114104759, filed Feb. 8, 2025, which is herein incorporated by reference.

### BACKGROUND

### Technical Field

The present disclosure relates to a pre-quantization circuitry and method, and more particularly, to a pre-quantization circuitry and method for computing-in-memory.

### Description of Related Art

In general computer architectures (such as Von Neumann architecture), a computing unit must first access and move data from a memory to the computing unit before performing calculations. Such computer architectures, like Von Neumann architecture, may perform efficiently when the calculations are relatively difficult. However, due to the special nature of neural network calculations, the calculations themselves are simple, but the amount of data is enormous. If Von Neumann architecture is utilized for neural network calculations, the access and movement of large amounts of data may become a bottleneck for power consumption and computing speed. Therefore, a so-called non-Von Neumann architecture emerges, aiming to blur the boundary between the computing unit and the memory, and to become a design architecture based on data flow.

Computing-in-memory (CIM) architecture is a type of non-Van Neumann architecture. The concept of the CIM architecture is to integrate a computing unit and a memory in the same circuitry at a transistor level. This may significantly reduce the power consumption of data reading and moving and break through the bottleneck of computing speed.

### SUMMARY

The objective of the present disclosure is to provide a pre-quantization circuitry and a pre-quantization method for computing-in-memory. Before an analog multiply-accumulate circuitry in the pre-quantization circuitry performs a multiply accumulation operation, the analog multiply-accumulate circuitry obtains pre-quantization information by pre-calculating weighted bit data configured in the memory with arithmetic function through software, so as to pre-quantize the first few most significant bits (MSB) of analog-to-digital conversion, thereby determining the number of conversion bits that may be omitted from an analog-to-digital converter (ADC). This achieves the effect of eliminating the need for detection circuitries, reducing the number of conversion bits of the ADC, saving power consumption, and saving electricity.

One aspect of the present disclosure relates to a pre-quantization circuitry for computing-in-memory. The pre-quantization circuitry includes an analog multiply-accumulate circuitry and an ADC. The analog multiply-accumulate circuitry is configured to receive a set of weights from a memory and an input feature from a register, and perform a multiply-accumulation (MAC) operation utilizing the set of weights and the input feature to generate an analog voltage/current. The ADC is configured to convert the analog voltage/current into a digital code. The analog multiply-accumulate circuitry is further configured to determine pre-quantization information of the ADC before performing the MAC operation. The ADC is further configured to convert the analog voltage/current into the corresponding digital code based on the pre-quantization information.

In accordance with one or more embodiments of the present disclosure, the analog multiply-accumulate circuitry is further configured to determine whether the set of weights are fully utilized after the ADC converts the analog voltage/current into the corresponding digital code.

In accordance with one or more embodiments of the present disclosure, the analog multiply-accumulate circuitry is further configured to load a set of updated weights from the memory after determining that the set of weights are fully utilized.

In accordance with one or more embodiments of the present disclosure, the analog multiply-accumulate circuitry is further configured to continue to utilize the set of weights and the input feature to perform the MAC operation to generate the analog voltage/current in response to determining that the set of weights are not fully utilized.

In accordance with one or more embodiments of the present disclosure, the ADC is a successive-approximation register ADC (SAR ADC).

In accordance with one or more embodiments of the present disclosure, the pre-quantization information is a number of bits to be resolved by the ADC.

In accordance with one or more embodiments of the present disclosure, the analog multiply-accumulate circuitry is configured to obtain the pre-quantization information by software.

In accordance with one or more embodiments of the present disclosure, the set of weights loaded by the analog multiply-accumulate circuitry are in a digital form.

Another aspect of the present disclosure relates to a neural network processing method, which includes the following steps: receiving, at an analog multiply-accumulate circuitry, a set of weights from a memory and receiving an input feature from a register; performing, by the analog multiply-accumulate circuitry, a MAC operation utilizing the set of weights and the input feature through the analog multiply-accumulate circuitry to generate an analog voltage/current; converting the analog voltage/current into a corresponding digital code utilizing an ADC; determining, by the analog multiply-accumulate circuitry, pre-quantization information of the ADC before performing the MAC operation; and converting, by the analog multiply-accumulate circuitry, the analog voltage/current into the corresponding digital code based on the pre-quantization information.

In accordance with one or more embodiments of the present disclosure, the pre-quantization method further includes determining, by the analog multiply-accumulate circuitry, whether the set of weights are fully utilized after the ADC converts the analog voltage/current into the corresponding digital code.

In accordance with one or more embodiments of the present disclosure, the pre-quantization method further includes loading, by the analog multiply-accumulate circuitry, a set of updated weights from the memory after determining that the set of weights are fully utilized.

In accordance with one or more embodiments of the present disclosure, the pre-quantization method further includes performing, by the analog multiply-accumulate circuitry, the MAC operation to generate the analog voltage/current in response to determining that the set of weights are not fully utilized.

In accordance with one or more embodiments of the present disclosure, the pre-quantization information is a number of bits to be resolved by the ADC.

In accordance with one or more embodiments of the present disclosure, the pre-quantization information is obtained in a software manner.

In accordance with one or more embodiments of the present disclosure, the set of weights loaded by the analog multiply-accumulate circuitry are in a digital form.

### BRIEF DESCRIPTION OF THE DRAWINGS

This disclosure can be more fully understood by reading the following detailed description of the embodiments, with reference made to the accompanying drawings as follows:

FIG. 1 is an operation schematic diagram of a pre-quantization circuitry for computing-in-memory in accordance with some embodiments of the present disclosure.

FIG. 2 is a flowchart of a pre-quantization method for computing-in-memory in accordance with some embodiments of the present disclosure.

### DETAILED DESCRIPTION

Reference will now be made in detail to the present embodiments of this disclosure, examples of which are illustrated in the accompanying drawings. Wherever possible, the same reference numbers are utilized in the drawings and the description to refer to the same or like parts. The verb “couple” and its conjugated forms are meant to complete any type of required junction, including electrical, mechanical, or fluid, to form a singular object from two or more previously non-joined objects.

Neural network operations are composed of multiple layers of mathematical operations. Taking the common convolutional neural network (CNN) as an example, the computational workload of convolutional layers and fully-connected layers accounts for an extremely high proportion of the overall computational workload (approximately over 90%). Both of these operations are composed of multiply-accumulate (MAC) operations. In specific, the MAC operations are operations of multiplying input features and weights and then summing them. The pre-quantization circuitry for computing-in-memory (CIM) is utilized to handle the MAC operations, in which the weights are loaded from a memory (e.g., dynamic random-access memory, DRAM), while the input features are loaded from outside the pre-quantization circuitry (e.g., registers). It should be noted that the pre-quantization circuitry for CIM may be implemented in analog or digital ways, but this disclosure only discusses the pre-quantization circuitry for CIM implemented in analog way.

Although it is known that utilizing analog circuitries to implement artificial intelligence (AI) accelerators may have better energy efficiency than digital circuitries, since the neural network model system utilizes digital signals for transmission, if a pre-quantization circuitry for CIM implemented in analog way is to be utilized, a common practice is to first convert the value to be operated into an analog signal through a digital-to-analog converter (DAC) (for example, converting a set of weights loaded from a memory into a set of analog weights, and converting input features loaded from a register into analog input features), and perform operations through analog operators, and then convert it back into a digital signal through an analog-to-digital converter (ADC) for transmission. However, this may result in most of the power being consumed in the converter.

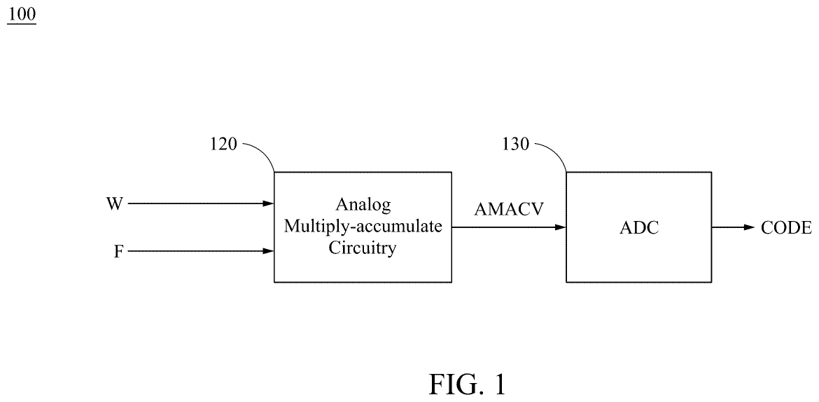

FIG. 1 is an operation schematic diagram of a pre-quantization circuitry for CIM in accordance with some embodiments of the present disclosure. As can be seen from FIG. 1, an analog multiply-accumulate circuitry 120 in the pre-quantization circuitry 100 first loads a set of weights W from a memory (not shown in FIG. 1) and loads input features F from a register (not shown in FIG. 1). Then, the analog multiply-accumulate circuitry 120 utilizes the set of weights W and the input features F to perform MAC operations to generate an analog voltage/current AMACV. It should be noted that, under normal circumstances, the set of weights W loaded by the analog multiply-accumulate circuitry 120 are in a digital form, while the input features F loaded by the analog multiply-accumulate circuitry 120 may be in a digital form or in an analog form (e.g., analog voltage sensed by a sensor), and the present disclosure does not limit this.

After the analog multiply-accumulate circuitry 120 performs MAC operations and generates the analog voltage/current AMACV, the analog voltage/current AMACV is then quantized into a corresponding digital code CODE by the ADC 130 (or called quantizer), thus completing the so-called CIM. It should be noted that the process of converting the analog voltage/current AMACV into the corresponding digital code CODE by the ADC 130 is the most power-consuming part of the pre-quantization circuitry 100. In detail, the analog multiply-accumulate circuitry 120 in the pre-quantization circuitry 100 is implemented in an analog way rather than a digital way because the analog multiply-accumulate circuitry 120 has the advantages of relatively high parallelism and low power consumption compared to the digital multiply-accumulate circuitry. However, the disadvantage of the analog multiply-accumulate circuitry 120 is that the generated multiply-accumulate voltage/current still needs to be converted from analog form to digital form through the ADC 130 for output. Therefore, how to reduce the power consumption of the ADC 130 becomes a critical issue in the design of the pre-quantization circuitry 100.

A common practice for reducing the power consumption of the pre-quantization circuitry 100 is to first perform analog judgment on the generated analog voltage/current AMACV after the analog multiply-accumulate circuitry 120 performs MAC operations utilizing the set of weights W and the input features F. In specific, for example, a detection circuitry is designed for analog judgment. When the detection circuitry determines that the value of the analog voltage/current AMACV is less than a certain analog threshold, the detection circuitry may control the ADC 130 to omit the resolution process of one or more most significant bits (MSBs). In other words, by reducing the operation of some circuitries in the ADC 130, the power consumption of the ADC 130 is effectively reduced. Conversely, when the detection circuitry determines that the value of the analog voltage/current AMACV is greater than or equal to the certain analog threshold, the detection circuitry may control the ADC 130 to still perform the normal resolution process.

However, it can be observed that the weights of the neural network are sparsity; that is, among all the weights trained by the neural network, the majority of the weights have a value of 0. Furthermore, in general, a set of weights W may be reused dozens, hundreds, or even thousands of times after being loaded into the pre-quantization circuitry 100 for CIM, without having to be loaded again and again. In other words, during the operation, only different input features F need to be loaded into the pre-quantization circuitry 100 for CIM from the register, and the set of weights W only needs to be loaded once. Only after this set of weights Wis fully utilized will a new set of updated weights be loaded into the pre-quantization circuitry 100 for CIM, and so on.

In one embodiment of the present disclosure, a maximum value of the analog voltage/current AMACV may be calculated by the following formula (1), denoted as MACVₘₐₓ.

$${MACV}_{max} = {IF}_{max} \times {\sum }_{i = 1}^{c} ( {W}_{i} ) , \qquad ( 1 )$$

where IFₘₐₓ represents a maximum value of input features F defined by a circuitry designer, Wᵢ represents pre-trained and known weight values of the neural network, c is the number of non-zero weight values, and

$${\sum }_{i = 1}^{c} ( {W}_{i} )$$

represents the sum of these weight values.

It is known that the common practice for reducing the power consumption of the pre-quantization circuitry 100 is to perform MAC operations utilizing the set of weights W and the input features F in the analog multiply-accumulate circuitry 120 before performing analog judgment on the generated analog voltage/current AMACV value. Based on the common practice, the present disclosure further adds the concept of pre-quantization. When it is known that most of the weights trained by the neural network have a value of 0, the step of performing analog judgment may be moved from after the MAC operations to before the MAC operations. In other words, the method of reducing power consumption through pre-quantization technology proposed in the present disclosure is that before performing MAC operations utilizing the set of weights W and the input features F, the analog multiply-accumulate circuitry 120 may obtain pre-quantization information by software. That is, the analog multiply-accumulate circuitry 120 may calculate the number of weight values with non-zero weight bits in a software manner, and know a maximum value of a result of MAC operations in advance based on the number of these non-zero weight values, so as to pre-quantize the number of bits to be resolved by the ADC 130, thereby determining the resolution process that may be omitted by the ADC 130. Compared to current methods for reducing power consumption, the advantage of moving the analog judgment step from after the MAC operations to before the MAC operations is that: the current methods require an analog threshold judgment to be performed after each MAC operation, for example, through a detection circuitry. Each judgment consumes power, and the time spent on each judgment also increases the resolution time of the ADC 130, resulting in slower operation speed. In contrast, the method proposed in the present disclosure calculates the number of non-zero weight values in the weight bits to pre-quantize the number of bits that the ADC 130 needs to resolve, thereby determining the resolution process that may be omitted by the ADC 130 (because once a set of weights W is loaded into the pre-quantization circuitry 100, the set of weights W does not need to be loaded again for modification until it is utilized up). The method proposed in the present disclosure saves the cost of designing a detection circuitry, avoids the power consumption caused by multiple analog threshold judgments, and does not increase the resolution time of the ADC 130 due to the time spent on multiple analog threshold judgments.

In other words, the common practice of reducing the power consumption of the pre-quantization circuitry 100 may be regarded as making an analog judgment based on the value of the analog voltage/current AMACV

$$( e . g . , {IF}_{max} \times {\sum }_{i = 1}^{c} ( {W}_{i} ) ) ,$$

while the method proposed in the present disclosure to reduce the power consumption of the pre-quantization circuitry 100 only makes an analog judgment based on the set of weights W loaded by the memory

$$( e . g . , {\sum }_{i = 1}^{c} ( {W}_{i} ) ) ,$$

In some embodiments, the ADC 130 in the pre-quantization circuitry 100 is a successive-approximation register (SAR) ADC. It should be noted that although the present disclosure implements the proposed pre-quantization circuitry 100 utilizing the SAR ADC, other suitable ADC 130 may also be utilized to implement the proposed pre-quantization circuitry 100, and the present disclosure does not limit this.

As mentioned above, the set of weights W may be reused dozens, hundreds, or even thousands of times after being loaded into the pre-quantization circuitry 100 for CIM, without having to be loaded again and again. Therefore, after the analog voltage/current AMACV is converted into the corresponding digital code CODE by the ADC 130, the analog multiply-accumulate circuitry 120 may then determine whether the set of weights W is fully utilized. In one embodiment of the present disclosure, when the analog multiply-accumulate circuitry 120 determines that the set of weights W is fully utilized, the analog multiply-accumulate circuitry 120 may load an updated set of weights from the memory to replace the original set of weights W. In another embodiment of the present disclosure, when the analog multiply-accumulate circuitry 120 determines that the set of weights W is not fully utilized, the analog multiply-accumulate circuitry 120 may continue to utilize the set of weights W and the input features F to perform MAC operations to generate the analog voltage/current AMACV.

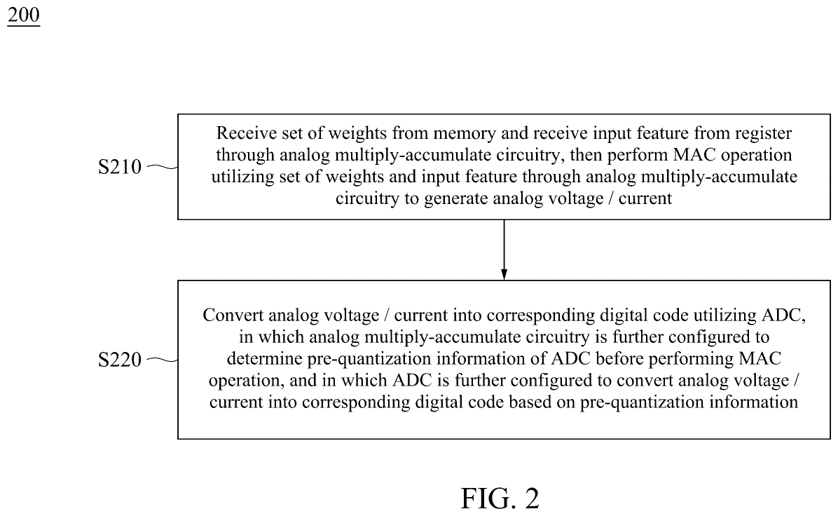

FIG. 2 is a flowchart of a pre-quantization method for computing-in-memory in accordance with some embodiments of the present disclosure. The pre-quantization method 200 for CIM may be performed by, for example, the pre-quantization circuitry 100 of FIG. 1, which includes the analog multiply-accumulate circuitry 120 and the ADC 130, or other similar circuitries. As shown in FIG. 2, the pre-quantization method 200 includes Steps S210 to S220. The following paragraphs describe the implementation of each step in the pre-quantization method 200 in conjunction with FIG. 1 and FIG. 2.
S210: receive a set of weights from a memory and receive an input feature from a register through an analog multiply-accumulate circuitry, then perform a MAC operation utilizing the set of weights and the input feature through the analog multiply-accumulate circuitry to generate an analog voltage/current.
S220: convert the analog voltage/current into a corresponding digital code utilizing an ADC, in which the analog multiply-accumulate circuitry is further configured to determine pre-quantization information of the ADC before performing the MAC operation, and in which the analog-to-digital converter is further configured to convert the analog voltage/current into the corresponding digital code based on the pre-quantization information.

The explanation of Steps S210 to S220 above may be found in the operation of the components (including but not limited to the analog multiply-accumulate circuitry 120 and the ADC 130) in the pre-quantization circuitry 100 for CIM as shown in FIG. 1, and will not be repeated here.

As can be seen from the above description, the pre-quantization circuitry and pre-quantization method of the present disclosure obtain pre-quantization information through software before the analog multiply-accumulate circuitry in the pre-quantization circuitry perform a multiply-accumulate operation. This allows for the pre-quantization of the number of bits required for the ADC to resolve, thereby determining the resolution process that may be omitted in the ADC. This achieves the effect of saving design costs of detection circuitries, saving power consumption, and saving electricity.

It will be apparent to those skilled in the art that various modifications and variations can be made to the structure of the present disclosure without departing from the scope or spirit of this disclosure. In view of the foregoing, it is intended that the present disclosure covers modifications and variations of this disclosure provided they fall within the scope of the following claims.

What is claimed is:

1. A pre-quantization circuitry for computing-in-memory, comprising:
an analog multiply-accumulate circuitry configured to receive a set of weights from a memory and an input feature from a register, and perform a multiply-accumulation (MAC) operation utilizing the set of weights and the input feature to generate an analog voltage/current; and
an analog-to-digital converter (ADC) configured to convert the analog voltage/current into a digital code,
wherein the analog multiply-accumulate circuitry is further configured to determine pre-quantization information of the ADC before performing the MAC operation, and
wherein the ADC is further configured to convert the analog voltage/current into the corresponding digital code based on the pre-quantization information.

2. The pre-quantization circuitry of claim 1, wherein the analog multiply-accumulate circuitry is further configured to determine whether the set of weights are fully utilized after the ADC converts the analog voltage/current into the corresponding digital code.

3. The pre-quantization circuitry of claim 2, wherein the analog multiply-accumulate circuitry is further configured to load a set of updated weights from the memory after determining that the set of weights are fully utilized.

4. The pre-quantization circuitry of claim 2, wherein the analog multiply-accumulate circuitry is further configured to continue to utilize the set of weights and the input feature to perform the MAC operation to generate the analog voltage/current in response to determining that the set of weights are not fully utilized.

5. The pre-quantization circuitry of claim 1, wherein the ADC is a successive-approximation register ADC (SAR ADC).

6. The pre-quantization circuitry of claim 1, wherein the pre-quantization information is a number of bits to be resolved by the ADC.

7. The pre-quantization circuitry of claim 1, wherein the analog multiply-accumulate circuitry is configured to obtain the pre-quantization information by software.

8. The pre-quantization circuitry of claim 1, wherein the set of weights loaded by the analog multiply-accumulate circuitry are in a digital form.

9. A pre-quantization method for computing-in-memory, comprising:
receiving, at an analog multiply-accumulate circuitry, a set of weights from a memory and receiving an input feature from a register;
performing, by the analog multiply-accumulate circuitry, a MAC operation utilizing the set of weights and the input feature through the analog multiply-accumulate circuitry to generate an analog voltage/current; and
converting the analog voltage/current into a corresponding digital code utilizing an ADC,
determining, by the analog multiply-accumulate circuitry, pre-quantization information of the ADC before performing the MAC operation, and
converting, by the analog multiply-accumulate circuitry, the analog voltage/current into the corresponding digital code based on the pre-quantization information.

10. The pre-quantization method of claim 9, further comprising:
determining, by the analog multiply-accumulate circuitry, whether the set of weights are fully utilized after the ADC converts the analog voltage/current into the corresponding digital code.

11. The pre-quantization method of claim 10, further comprising:
loading, by the analog multiply-accumulate circuitry, a set of updated weights from the memory after determining that the set of weights are fully utilized.

12. The pre-quantization method of claim 10, further comprising:
continuing, by the analog multiply-accumulate circuitry, to utilize the set of weights and the input feature to perform the MAC operation to generate the analog voltage/current in response to determining that the set of weights are not fully utilized.

13. The pre-quantization method of claim 9, wherein the pre-quantization information is a number of bits to be resolved by the ADC.

14. The pre-quantization method of claim 9, wherein the pre-quantization information is obtained in a software manner.

15. The pre-quantization method of claim 9, wherein the set of weights loaded by the analog multiply-accumulate circuitry are in a digital form.
